(19) United States
(12) Patent Application Publication
(10) Pub. No.: US 2019/0330407 A1
(43) Pub. Date: Oct. 31, 2019

(54) POLYMERS FOR HYDROPHOBIC AND OLEOPHOBIC TEXTILE FINISHING

(71) Applicant: Evonik Degussa GmbH, Essen (DE)

(72) Inventors: Sadik Amajjahe, Düsseldorf (DE); Gabriele Platte, Castrop-Rauxel (DE); Kai Oliver Wirz, Moseley, VA (US); Jörg Peggau, Essen (DE); Sarah Radloff, Bochum (DE); Kathrin Stremmer, Essen (DE)

(73) Assignee: Evonik Degussa GmbH, Essen (DE)

(21) Appl. No.: 16/471,306

(22) PCT Filed: Feb. 2, 2018
(86) PCT No.: PCT/EP2018/052646

§ 371 Date: Jun. 19, 2019

(30) Foreign Application Priority Data
Feb. 9, 2017 (EP) 17155342.3

(51) Int. Cl. C08G 18/69; C08G 18/79; C08L 75/04; C08G 18/22; C08G 18/28; C08G 18/61; C08G 18/78; C08G 18/80; C09D 175/04; D06M 15/227; D06M 15/564; D06M 15/653

(52) U.S. Cl. CPC C08G 18/69; C08G 18/792; C08L 75/04; C08G 18/227; C08G 18/2825; C08G 18/61; C08L 2201/52; C08G 18/8067; C09D 175/04; D06M 15/227; D06M 15/564; D06M 15/653; C08G 18/7831

(57) ABSTRACT

The invention relates to copolymers comprising or consisting of, preferably consisting of three components:

component a) having at least one biuret or isocyanurate substructure,
component b) selected from polysiloxanes and polyhydrocarbons, preferably polysiloxanes,
component c) comprising a hydrocarbon which is different from component b) and has at least 6 carbon atoms and not more than 3 heteroatoms selected from the group of N, 0, S,
where component b) is joined to 2 different or identical components a) via at least two positions; and to the preparation and use thereof for finishing of fabrics.

### CROSS REFERENCE TO RELATED APPLICATIONS

This application is a 35 U.S.C. § 371 U.S. national phase entry of International Application No. PCT/EP2018/052646 having an international filing date of Feb. 2, 2018, which claims the benefit of European Application No. 17155342.3 filed Feb. 9, 2017, each of which is incorporated herein by reference in its entirety.

### FIELD

The invention relates to formulations based on water and/or organic solvents and to the use thereof as finish on fabrics.

### BACKGROUND

It is known that, for finishing of fabrics, water-based or solvent-based formulations composed of silicone oils, paraffins, fluorocarbon polymers (fluorocarbon is abbreviated to FC hereinafter) and other additives are used, which impart particular hydrophobic effects to the finished fabric, in order to cope with stresses by rain, splash water or moisture from other sources during the use of the fabric.

Whereas the creation of water-repellent effects with products based on paraffins and silicones brings about merely hydrophobization of the textile fibers, FC polymers additionally lead to soil and oil repellency. FC finishes are useful for a large number of articles. They are used both in the clothing and domestic textiles sector and in the technical textiles sector. Typically, products for FC finishing are based on polyurethanes or polyacrylates containing perfluoroalkyl groups of different chain length. The aqueous products are usually applied via the exhaustion process and padding process via spraying, foaming or padding, frequently in combination with other additives. These additives may, for example, be heat-curing resins based on methylol compounds that bring about dimensional stability, washfastness and stiffness. For instance, U.S. Pat. No. 6,127,507 and WO 2010/025398 disclose fluoroalkyl-containing polymers of this kind.

Also used in addition are substances that are referred to as extenders. Typically, these are fatty acid-modified melamine resins, mixtures of wax and zirconium salts, or blocked polyisocyanates. The latter are frequently used in order to improve the water- and oil-repellent effects of the FC finish and to increase washing permanence.

A disadvantage is that, even after a few washes, both the hydrophobicity and the oleophobicity are greatly reduced because of the loss of orientation of the active FC radicals in the polymer molecules, unless reorientation can take place through thermal treatment. This means that fabrics that have been treated in this way need a heat treatment after a wash in order to revitalize the desired effects. For example, ironing or at least drying in the laundry dryer at temperatures >80° C. are a prerequisite for good repellency properties. A significant disadvantage is their long lifetime in nature and organisms. Thus, FC polymers or degradation products thereof such as perfluorooctanoic acid accumulate in organisms, and are barely secreted from the human body. Studies have suggested liver-damaging, reprotoxic and carcinogenic properties. Among the most important sources of emissions are accordingly carpets and textiles that have been rendered soil- and water-repellent, and fire-extinguishing foam.

As well as good initial hydrophobicity, stability of the finish to repeated washing is another important aspect. There have therefore already been early developments that were intended to improve the inadequate stability to washing operations. For instance, DE 1017133 B describes hydrophobizing agents which are to be produced by mixing a condensation product formed from hexamethylolmelamine hexamethyl ether, stearic acid, stearic acid diglyceride and triethanolamine with paraffin. The products thus obtained in the form of flakes or lumps, prior to use, are converted to an emulsion form applicable from aqueous liquors by melting with hot water or steam and with addition of acetic acid. However, a disadvantage of the fabrics and fiber materials thus finished has been found to be that the relatively large amount applied, the chemical character of the formulation and especially the crosslinking of the fatty acid-modified methyloltriazine compound with itself and with the functional groups of native-based substrates were associated with a distinct increase in hardness of the hand character.

In addition, U.S. Pat. No. 5,589,563 discloses linear block copolymers prepared from diisocyanates by addition with exclusively difunctional compounds.

WO 2016/049278 discloses non-fluorinated urethanes as coating materials, the isocyanate base structure of which derives from sugar alcohols.

Methods of impregnating textiles by applying crosslinkable organopolysiloxanes have long been known. Crosslinking can be effected by condensation of Si—H- and Si—OH-functional organopolysiloxanes with the aid of a catalyst as described in U.S. Pat. No. 4,098,701. Likewise possible is crosslinking by addition of Si—H-functional organopolysiloxanes onto SiC-bonded olefinic radicals (U.S. Pat. No. 4,154,714 and DE 3332997 A1). Because of the reactive character of organopolysiloxanes of this kind, the production of storage-stable formulations is difficult. Frequently, the components cannot be mixed until directly prior to use, which makes them laborious to work with in practice.

WO 2000/029663 A2 describes formulations for permanent fiber finishing that comprise reaction products of polyisocyanate-functional compounds with silicone-free and/or silicone-containing softeners and, according to the examples, preferably include a hydrophilizing radical.

DE 19744612 A1 describes emulsions of organosilicon compounds for the hydrophobization of mineral building materials and building coatings, and also wood. The aqueous emulsions contain alkoxysilanes modified with long-chain hydrocarbon chains. However, no application to textiles is disclosed. In addition, U.S. Pat. No. 8,318,867 B2 describes copolymers based on a hard/soft concept with polyurethanes as hard segment, polybutadienes and polycarbonates as soft segment, and polyfluoroalkyl compounds as surface-active substance for finishing and additization of plastics and for increasing their thermal stability. With these systems, it is possible to achieve very good water-repellent effects, but relatively high use amounts are required. The effect of this is that the breathability of the finished textile is reduced. Similarly to the case of textiles treated with the FC-containing formulations, washing has to be followed by a thermal treatment, for example in a laundry dryer or by ironing, in order to restore the original effect level.

A representative having a water-repellent effect which is known in nature is the lotus plant. Water drips off in droplets and in so doing takes all the soil particles on the surface with it. What is responsible for this is a complex micro- and nanoscopic architecture of the surface that minimizes the adhesion of soil particles. The disadvantage is that a slight decrease in the surface tension of the liquid (for example by addition of milk) has the effect that the liquid can no longer be washed off. The cause of the self-cleaning lies in a hydrophobic twin structure of the surface. This twin structure is formed from an epidermis in characteristic form and waxes present thereon. These overlaid waxes are hydrophobic and form the second part of the twin structure. It is thus no longer possible for water to get into the interstices in the leaf surface, the result of which is that the contact area between water and the surface is reduced.

Water- and oil-repellent systems are known in the world of insects (Interface Science No. 14, pages 270-280, 2009) in the Collembola, also called springtails. The armour cannot be wetted even by acetone and ethanol. This superhydrophobic armour results from its unique structure based on proteins and waxes.

### SUMMARY

It was an object of the present invention to provide silicone-containing structures with marked microstructure which achieve optimal hydrophobic and oleophobic effects on fabrics with small use amounts.

Surprisingly, copolymers containing not only polysiloxanes but also further components (synonymous with the term “substructures”) such as polyisocyanates and larger organic hydrocarbyl radicals as described in the claims have both hydrophobic and oleophobic properties.

### DETAILED DESCRIPTION

The present invention provides copolymers comprising the following constituents or consisting of the following constituents, preferably consisting of the following constituents:
component a) having at least one biuret or isocyanurate substructure,
component b) selected from polysiloxanes and polyhydrocarbons, preferably from polysiloxanes,
component c) comprising a hydrocarbon which is different from component b) and has at least 6 carbon atoms and not more than 3 heteroatoms selected from the group of N, O, S,
   where component b) is joined to 2 different or identical components a) via at least two positions.

The present invention further provides a process for preparing the copolymers according to the invention.

The present invention further provides compositions comprising the copolymers according to the invention or the process products according to the invention.

The present invention further provides aqueous emulsions comprising the copolymers according to the invention or the process products according to the invention.

The present invention further provides for the use of the copolymers according to the invention, the process products according to the invention and the compositions according to the invention for finishing of fabrics.

The present invention further provides a process for liquid- and soil-repellent impregnation of textile fabrics by using the copolymers according to the invention.

The invention further provides repellent textile fabrics comprising the copolymers according to the invention with retention or improvement of the tactile properties.

The copolymers according to the invention have environmental advantages over the FC polymers:
reduced environmental pollution
more environmentally compatible polymers that do not damage the environment even in the long term
no use of persistent compounds.

A further advantage of the copolymers of the invention is their extremely good mechanical stability on fabrics.

A further advantage of the invention is that the textiles finished with the copolymers according to the invention have unchanged breathability.

A further advantage of the invention is that the textiles finished with the copolymers according to the invention, even after multiple washes, have a high effect level without any further thermal treatment.

A further advantage of the invention is that the coating of textiles with the copolymers according to the invention has an improvement in the tactile properties and leads to pleasant wearing comfort.

A further advantage of the copolymers according to the invention is their versatile applicability to cellulose- and lignin-based fibers.

A further advantage is the reduction in wastewater pollution compared to the prior art both in production and in use.

The copolymers according to the invention, the process according to the invention for preparation of the copolymers, and the compositions and aqueous emulsions according to the invention and the inventive use thereof are described by way of example hereinafter, without any intention that the invention be restricted to these illustrative embodiments. When ranges, general formulae or classes of compounds are specified below, these are intended to encompass not only the corresponding ranges or groups of compounds which are explicitly mentioned but also all subranges and subgroups of compounds which can be derived by leaving out individual values (ranges) or compounds. Where documents are cited for the purposes of the present description, the entire content of these is intended to be part of the disclosure of the present invention. Where content figures (ppm or %) are given below, unless otherwise indicated, they are figures in % by weight or ppm by weight (wppm). In the case of compositions, the content figures, unless otherwise indicated, are based on the overall composition. Averages recited hereinbelow are number averages unless otherwise stated. Molar masses used are weight-average molar masses Mw unless expressly stated otherwise. Viscosity values recited in the context of this invention are, unless otherwise stated, dynamic viscosities which can be determined using methods familiar to those skilled in the art. Where measured values are recited hereinbelow, these measured values were determined at a pressure of 101 325 Pa and a temperature of 23° C. unless otherwise stated.

The various fragments in the formulae (I) and (VII) are in statistical distribution. Statistical distributions are of blockwise construction with any desired number of blocks and with any desired sequence or are subject to a randomized distribution; they may also have an alternating construction or else form a gradient over the chain; more particularly they can also form any mixed forms in which groups with different distributions may optionally follow one another. The nature of specific embodiments can result in restrictions to the statistical distributions. In all regions unaffected by the restriction there is no change to the statistical distribution.

The indices shown in the formulae (I) and (VII) cited here, and the ranges of values for the indices stated, should be understood as the average values of the possible statistical distribution of the structures and/or mixtures thereof that are actually present. This also applies to structural formulae exactly reproduced per se as such.

Wherever molecules/molecule fragments have one or more stereocentres or can be differentiated into isomers on account of symmetries or can be differentiated into isomers on account of other effects e.g. restricted rotation, all possible isomers are included by the present invention.

In connection with this invention, the word fragment “poly” encompasses not only exclusively compounds with at least 3 repeat units of one or more monomers in the molecule, but especially also those compositions of compounds which have a molecular weight distribution and at the same time have an average molecular weight of at least 200 g/mol. This definition takes account of the fact that it is customary in the field of industry in question to refer to such compounds as polymers even if they do not appear to conform to a polymer definition as per OECD or REACH guidelines.

The indices recited herein and the value ranges for the indicated indices can be understood as average values for the possible statistical distribution of the actual existing structures and/or mixtures thereof. This applies equally to structural formulae which as such are reproduced exactly per se, such are for formula (I) and formula (VII), for example.

Preferably, the copolymer consists of components a), b) and component c), where one or more selected from components a), b) and c) may be present in each case.

Further preferably, the copolymer according to the invention is free of isocyanate groups.

Further preferably, the copolymer is free of halogen atoms, more preferably free of fluorine atoms.

Further preferably, the copolymer is free of polyether structures, more preferably free of oxyalkylene fragments bonded to one another.

Further preferably, the copolymer has components a) and c) in a ratio of number of c) divided by number of a) of 1 to 3, more preferably of 1.3 to 2.7, particularly preferably of 1.6 to 2.4 and especially preferably of 1.8 to 2.2.

Preferably, component a) in each case has two or more biuret or isocyanurate substructures, more preferably from more than 1 to 4, even more preferably from 1.2 to 3, particularly preferably from 1.3 to 2.5, and especially preferably from 1.4 to 2 biuret or isocyanurate substructures.

More preferably, the copolymer according to the invention has components a) and c) in a ratio of number of c) divided by number of a) of 1 to 3, more preferably of 1.3 to 2.7, particularly preferably of 1.6 to 2.4 and especially preferably of 1.8 to 2.2; and has, in component a), two or more biuret or isocyanurate substructures in each case, more preferably from more than 1 up to 4, even more preferably from 1.2 to 3, particularly preferably from 1.3 to 2.5 and especially preferably from 1.4 to 2 biuret or isocyanurate substructures.

Further preferably, component a) is independently identical or different biuret substructures of the formula (III) and isocyanurate substructures of the formula (IV)

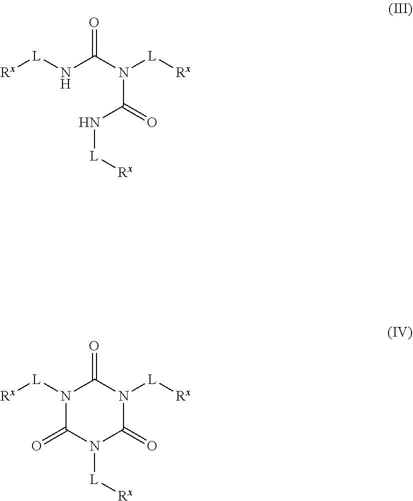

in which
L is divalent radicals of tolyl (2,4-; 2,6-), ethylphenyl, 1,5-naphthyl, α,ω-tetramethylene, α,ω-hexamethylene, α,ω-dodecamethylene, α,ω-2-methylpentamethylene, α,ω-2,2,4-trimethylhexamethylene, cyclohexyl (1,4-), 1-methylcyclohexyl (1,3-; 1,4-; 2,6-), 2,2,6-trimethylcyclohexyl, isophorone (3,3,5-trimethylcyclohexyl), 4,4′-dicyclohexylmethyl, 4,4′-dicyclohexylpropane-(2,2), 4,4′-diphenylmethane, preferably hexamethylene, 4,4′-diphenylmethane and isophorone.

For instance, the divalent L radicals derive from the diisocyanates selected from toluene 2,4-/2,6-diisocyanate (TDI), diphenylmethane 4,4′-diisocyanate (MDI), naphthyl 1,5-diisocyanate (NDI), dicyclohexylmethane 4,4′-diisocyanate, 3-isocyanatomethyl-3,3,5-trimethylcyclohexyl isocyanate (isophorone diisocyanate=IPDI), butane 1,4-diisocyanate, hexane 1,6-diisocyanate (HDI), 2-methylpentane 1,5-diisocyanate, 2,2,4-trimethylhexane 1,6-diisocyanate (TMDI), dodecane 1,12-diisocyanate, cyclohexane 1,4-diisocyanate, 3,3′-dimethyldicyclohexylmethane 4,4′-diisocyanate, dicyclohexylpropane-(2,2)-4,4′-diisocyanate, 3-isocyanatomethyl-1-methyl-1-isocyanatocyclohexane (MCI), 2-methylcyclohexane 1,3-diisocyanate.

R^{x} is independently the bonding site to component b) and component c),
and denotes a urethane group or urea group in the case of the bond to component b),
and denotes a urethane group, a urea group or a thiourea group in the case of the bond to component c),
   where these urethane, urea and thiourea groups are bonded via the nitrogen atom to formula (III) and formula (IV),
or R^{x} denotes a bond to a further biuret or isocyanurate substructure, preferably with bonding of biuret substructures to biuret substructures and preferably of isocyanurate substructures to isocyanurate substructures.

The bond between component a) and component b) can be represented by formula (V):

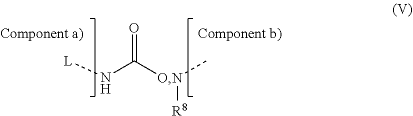

The bond between components a) and c) can be represented by formula (VI):

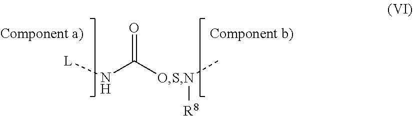

where
R⁸ is hydrogen or a substituted or unsubstituted C₁-C₃O-alkyl, preferably substituted or unsubstituted C₁-C₃O-alkyl which may also be interrupted by heteroatoms, cyclic C₃-C₃O-alkyl, substituted or unsubstituted C₆-C₃O-aryl,
   R⁸ preferably being a C₁-C₅-alkyl.

If appropriate, the N—H groups in the formulae (V) and (VI) can react with further isocyanate groups to give allophanates and further biuret structures.

Further preferably, component a) has either exclusively biuret or exclusively isocyanurate substructures, component a) particularly preferably having exclusively isocyanurate substructures.

Further preferably, component b) is bonded exclusively to component a). More preferably, component a) and component b) are bonded to one another via urethane or urea groups.

Further preferably, component c) is bonded exclusively to component a). Further more preferably, component a) and component c) are bonded to one another via urethane, urea and/or thiourea groups.

Component b) is selected from the group consisting of polysiloxanes and polyhydrocarbons. It is especially preferable that component b) is selected from the group consisting of polysiloxanes.

Preferably, the polyhydrocarbon of component b) is a linear or branched, saturated or unsaturated hydrocarbon.

More preferably, the polyhydrocarbon of component b) has one or more double bonds and/or triple bonds which may be isolated, conjugated or cumulated.

Especially preferably, the polyhydrocarbon of component b) has 20 to 400 carbon atoms, further preferably 40 to 200, especially preferably 60 to 120, carbon atoms.

Further preferably, component b) is selected from the group comprising polysiloxanes and polybutadienes, preferably polysiloxanes.

Preferably, the polysiloxane is a compound of the formula (I)

M¹ₐ₁M²ₐ₂M³ₐ₃D¹_{b1}D²_{b2}D³_{b3}T_{c}Q_{d} (I)

with

| | | |
|---|---|---|
| M¹ = [R¹₃SiO_{1/2}], | M² = [R²R¹₂SiO_{1/2}], | M³ = [R³R¹₂SiO_{1/2}], |
| D¹ = [R¹₂SiO_{2/2}], | D² = [R¹R²SiO_{2/2}], | D³ = [R¹R³SiO_{2/2}], |
| T = [R¹SiO_{3/2}], | | |
| Q = [SiO_{4/2}], | | |

where
a1=0 to 20, preferably 1 to 10, especially 2 to 5;
a2=0 to 10, preferably 0 to 5, especially 0;
a3=0 to 20, preferably 1 to 10, especially 2 to 5;
b1=1 to 1000, preferably 5 to 500, especially 10 to 200;
b2=0 to 10, preferably 0 to 5, especially 0;
b3=0 to 20, preferably greater than 0 up to 10, especially 1 to 5;
c=0 to 10, preferably greater than 0 up to 5, especially 1 to 5;
d=0 to 50, preferably 0 to 10, especially 0 to 2;
with the proviso that at least one of the indices a3 and b3 is greater than 1, the sum total of a3 and b3 preferably being at least 2;
R¹=independently identical or different linear or branched, saturated or unsaturated hydrocarbyl radicals having 1 to 30 carbon atoms or aromatic hydrocarbyl radicals having 6 to 30 carbon atoms,
   preferably alkyl radicals having 1 to 14 carbon atoms or monocyclic aromatics,
   further preferably methyl, ethyl, propyl or phenyl, especially methyl;
R²=independently identical or different linear or branched, saturated or unsaturated, optionally substituted hydrocarbyl radicals, where preferred hydrocarbons have 2 to 30 carbon atoms, more preferably 2 to 16 carbon atoms, where the substituents may be selected from methoxy, ethoxy, propoxy, butoxy, pentoxy and glycidyloxy,
   R² preferably being a glycidyloxy-substituted alkylene radical having 2 to 6 carbon atoms,
   R² especially preferably being a glycidyloxypropyl radical;
R³=a divalent hydrocarbon having 2 to 8 carbon atoms, preferably 2 to 6, especially preferably 2 to 3, the second bond of which is the bonding site to component a) via preferably a urethane or urea group.

Preferably, the polybutadiene is a compound of the formula (VII)

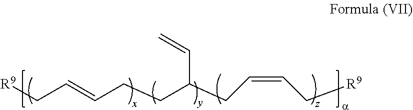

where
x=0.3 to 0.8, preferably 0.4 to 0.7, especially preferably 0.5 to 0.6,
y=0.01 to 0.35, preferably 0.1 to 0.3,
z=0.1 to 0.5, preferably 0.15 to 0.3,
the sum total of x, y and z is 1,
α=5 to 100, preferably 10 to 50, especially preferably 15 to 30,
R⁹ is the bonding site to component a) via preferably a urethane or urea group.

Further preferably, component c) is a hydrocarbon having exactly one bonding site to component a). The hydrocarbon has, apart from carbon and hydrogen, not more than 3 heteroatoms, more preferably not more than 2 heteroatoms, particularly preferably not more than one heteroatom and especially preferably no heteroatoms. If component c) has heteroatoms, these are selected from the group of N, O, S.

Component c) may also consist of a mixture of hydrocarbons.

Preferably, the hydrocarbon has 6 to 30 carbon atoms, preferably 12 to 26, more preferably 14 to 20.

More preferably, the hydrocarbon has an uninterrupted chain of at least 6 carbon atoms, preferably from 6 to 21 carbon atoms.

Likewise more preferably, the hydrocarbon has one or more double bonds and/or triple bonds which may be isolated, conjugated or cumulated.

More preferably, the hydrocarbon has aromatic rings, preferably one or more benzene rings, one of the aromatic rings particularly preferably having the bonding site to component a).

Further particularly preferably, the copolymers of the invention have, as component a), independently identical or different biuret substructures of the formula (III) and isocyanurate substructures of the formula (IV)

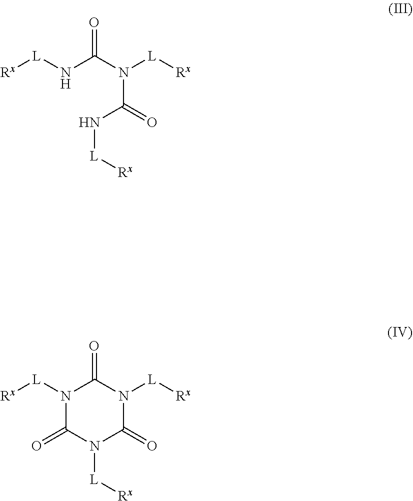

in which
L is divalent radicals of tolyl, ethylphenyl, 1,5-naphthyl, α,ω-hexamethylene, isophorone, 2,2,6-trimethylcyclohexyl, 4,4′-dicyclohexylmethyl, 4,4′-diphenylmethane, preferably hexamethylene and isophorone,
R^{x} is independently the bonding site to component b) and component c),
   and denotes a urethane group or urea group in the case of the bond to component b),
   and denotes a urethane group, a urea group or a thiourea group in the case of the bond to component c),
      where these urethane, urea and thiourea groups are bonded via the nitrogen atom to formula (III) and formula (IV),
   or R^{x} denotes a bond to a further biuret or isocyanurate substructure, preferably with bonding of biuret substructures to biuret substructures and preferably of isocyanurate substructures to isocyanurate substructures;
and have, as component b), preferably a polysiloxane of the formula (I)

M¹ₐ₁M²ₐ₂M³ₐ₃D¹_{b1}D²_{b2}D³_{b3}T_{c}Q_{d} (I)
with

| | | |
|---|---|---|
| M¹ = [R¹₃SiO_{1/2}], | M² = [R²R¹₂SiO_{1/2}], | M³ = [R³R¹₂SiO_{1/2}], |
| D¹ = [R¹₂SiO_{2/2}], | D² = [R¹R²SiO_{2/2}], | D³ = [R¹R³SiO_{2/2}], |
| T = [R¹SiO_{3/2}], | | |
| Q = [SiO_{4/2}], | | |

where
a1=0 to 20, preferably 1 to 10, especially 2 to 5;
a2=0 to 10, preferably 0 to 5, especially 0;
a3=0 to 20, preferably 1 to 10, especially 2 to 5;
b1=1 to 1000, preferably 5 to 500, especially 10 to 200;
b2=0 to 10, preferably 0 to 5, especially 0;
b3=0 to 20, preferably greater than 0 up to 10, especially 1 to 5;
c=0 to 10, preferably greater than 0 up to 5, especially 1 to 5;
d=0 to 50, preferably 0 to 10, especially 0 to 2;
with the proviso that at least one of the indices a3 and b3 is greater than 1, preferably greater than 2;
R¹=independently identical or different linear or branched, saturated or unsaturated hydrocarbyl radicals having 1 to 30 carbon atoms or aromatic hydrocarbyl radicals having 6 to 30 carbon atoms,
   preferably alkyl radicals having 1 to 14 carbon atoms or monocyclic aromatics,
   further preferably methyl, ethyl, propyl or phenyl, especially methyl;
R²=independently identical or different linear or branched, saturated or unsaturated, optionally substituted hydrocarbyl radicals, where preferred hydrocarbons have 2 to 30 carbon atoms, more preferably 2 to 16 carbon atoms, where the substituents may be selected from methoxy, ethoxy, propoxy, butoxy, pentoxy, glycidyloxy,
   R² preferably being a glycidyloxy-substituted alkylene radical having 2 to 6 carbon atoms,
   R² especially preferably being a glycidyloxypropyl radical;
R³=a divalent hydrocarbon having 2 to 8 carbon atoms, preferably 2 to 6, especially preferably 2 to 3, the second bond of which is the bonding site to component a) via preferably a urethane or urea group;
and have, as component c), hydrocarbons having exactly one bonding site to component a), the hydrocarbons preferably having, aside from carbon and hydrogen, not more than 3 heteroatoms, more preferably not more than 2 heteroatoms, particularly preferably not more than one heteroatom and especially preferably no heteroatoms; if component c) has heteroatoms, these are preferably selected from the group of N, O, S.

Especially preferably, the copolymers according to the invention have in component a), as divalent L radical in the formula (III) or (IV), hexamethylene, 4,4′-diphenylmethane and isophorone;

in component b), a siloxane of the formula (I) with the indices
a3=2 to 5
a1=0 to 1
a2=0
b2 and b3=0
d=0
R¹=methyl or phenyl
   in component c), a hydrocarbon which is free of heteroatoms and has aromatic rings, preferably one or more benzene rings, one of the aromatic rings particularly preferably having the bonding site to component a).

The copolymers according to the invention can be prepared as per the prior art processes, but preferably by the process according to the invention, wherein, in the first step, an intermediate having components a) and components c) is prepared and, in the second step, the intermediates are converted to the copolymer according to the invention.

The process according to the invention for preparation of the copolymers according to the invention can preferably be executed in such a way that it comprises two process steps, namely 1. preparation of an intermediate comprising component a) and component c), and 2. reaction of the intermediate (from the 1st process step) with polymers bearing amine and/or hydroxyl groups, preferably polysiloxanes, to give the copolymers according to the invention (2nd process step). This corresponds to a preferred embodiment of the invention.

Both process steps of the aforementioned preferred embodiment of the invention (preparation of intermediate having component a) and component c), and reaction of the intermediate with polymers bearing amine and/or hydroxyl groups to give the copolymers of the invention (2nd process step)), can be performed in the process according to the invention either as a one-pot reaction, as successive, separately conducted steps, or else under metering control, but preferably under metering control. The reaction can be conducted in a batchwise, semibatchwise or continuous process. The one-pot reaction is especially preferred for process step 2.

Preferably, in the 1st step of the process according to the invention, biuret- and/or isocyanurate-containing polyisocyanates are reacted with reactive diluents.

Preferably, in the first step, isocyanate groups are converted to urethane and/or urea groups; the products formed here correspond to the intermediates according to the invention.

More preferably, in the first step, half to three quarters of isocyanate groups are converted.

In the 2nd step of the process according to the invention, the intermediates are reacted with polymers bearing amine and/or hydroxyl groups, preferably polysiloxanes, to give the copolymers according to the invention.

Preferably, the process products, after the 2nd step, are checked for the absence of isocyanate groups as described in the examples. If the test is negative, i.e. if isocyanate groups were still present, the batch is discarded.

The process according to the invention can be effected in the presence or in the absence of a solvent. Suitable inert organic solvents used are preferably anhydrous aliphatic and alicyclic hydrocarbons, for example hexane, heptane, cyclohexane, and ethers, for example diethyl ether, ethylene glycol dimethyl ether, diethylene glycol dimethyl ether, diisopropyl ether, esters, for example ethyl acetate, n-propyl acetate, i-propyl acetate, n-butyl acetate, i-butyl acetate, amyl acetate, ketones, for example acetone, methyl ethyl ketone, methyl isobutyl ketone, and mixtures thereof.

The reactants may be present here in any desired concentration in a solvent, for example 5% to 99% by weight, preferably 20% to 90% by weight, especially preferably 40% to 90% by weight.

In a preferred embodiment, the process according to the invention can be conducted at a temperature of 10° C. to 150° C., preferably of 25° C. to 100° C., more preferably of 40° C. to 90° C.

In a preferred embodiment, the process according to the invention can preferably be conducted at a pressure of 0.5 to 20 bar, preferably 1 to 5 bar, especially preferably at standard pressure.

The reaction according to the invention can be conducted either in daylight or with exclusion of light, preferably in daylight.

The reaction according to the invention can be conducted either under inert conditions (nitrogen, argon) or under an oxygen and/or air atmosphere, preferably under a nitrogen atmosphere.

The biuret- and/or isocyanurate-containing polyisocyanates used in the 1st step of the process are preferably the trimers, tetramers, pentamers, hexamers and heptamers of bifunctional isocyanates, where the isocyanates are aromatic or aliphatic, preferably aliphatic. The bifunctional isocyanates may be selected from the group comprising toluene 2,4-/2,6-diisocyanate (TDI), diphenylmethane 4,4′-diisocyanate (MDI), naphthyl 1,5-diisocyanate (NDI), dicyclohexylmethane 4,4′-diisocyanate, 3-isocyanatomethyl-3,3,5-trimethylcyclohexyl isocyanate (isophorone diisocyanate=IPDI), butane 1,4-diisocyanate, hexane 1,6-diisocyanate (HDI), 2-methylpentane 1,5-diisocyanate, 2,2,4-trimethylhexane 1,6-diisocyanate (TMDI), dodecane 1,12-diisocyanate, cyclohexane 1,4-diisocyanate, 3,3′-dimethyldicyclohexylmethane 4,4′-diisocyanate, dicyclohexylpropane-(2,2)-4,4′-diisocyanate, 3-isocyanatomethyl-1-methyl-1-isocyanatocyclohexane (MCI), 2-methylcyclohexane 1,3-diisocyanate, preferably 3-isocyanatomethyl-3,3,5-trimethylcyclohexyl isocyanate (isophorone diisocyanate=IPDI), hexane 1,6-diisocyanate (HDI), particularly preferably hexane 1,6-diisocyanate (HDI).

Some of these isocyanates have stereocentres. In particular reference is made to the isomers of isophorone. All conceivable isomers are expressly incorporated in the scope of this invention. Thus, for example, isophorone diisocyanate can be differentiated into a cis and a trans isomer. Particular preference is given to an isophorone diisocyanate of a cis/trans mixture of 5:1 to 1:5, preferably 3:1 to 1:3, further preferably 1:1. A particularly preferred commercial product consists of a cis/trans mixture of 3:1. The use of commercial isophorone diisocyanate is preferred. Isophorone diisocyanate is obtainable under other names which are included as synonyms in the scope of this invention: 3-isocyanatomethyl-3,5,5-trimethylcyclohexyl isocyanate, 5-isocyanato-1-(isocyanatomethyl)-1,3,3-trimethylcy clohexane, CA RN: 4098-71-9. Various trade names are customary; they often contain the name of the parent molecule isophorone, although other trade names are also customary: e.g. Desmodur®I (BAYER), Isocur IPDI 22-200 (ISO-ELEKTRA), VESTANAT® IPDI (EVONIK INDUSTRIES), which are likewise incorporated within the scope of the present invention. Customary specifications for isophorone diisocyanate are: total chlorine content <400 mg/kg, hydrolysable chlorine <200 mg/kg, purity >99.5% by weight, refractive index n25D 1.483 (DIN 51 423, part 2), NCO content 37.5-37.8% by weight (EN ISO 11 909/ASTM D 2572), the commercial product is described as colorless to light yellow.

The biuret- and/or isocyanurate-containing polyisocyanates used with preference in the 1^{st} step of the process may be used individually or else as mixtures. They may be identical or different polyisocyanates. If, for example, different polyisocyanates are used, component b) may be joined to two different components a). If, for example, just one polyisocyanate is used, component b) is joined to 2 identical components a). Preferably, component b) is joined to 2 identical components a).

Reactive diluents in the context of the invention are preferably primary and/or secondary monoamines, monoalcohols and/or monothiols, the hydrocarbons of which each have 6 to 30 carbons, and which preferably have, apart from carbon and hydrogen, not more than 3 heteroatoms, more preferably not more than 2 heteroatoms, particularly preferably not more than one heteroatom and especially preferably no heteroatoms. If the hydrocarbon has heteroatoms, these are preferably selected from the group of N, O, S. The terms “monoamines”, “monoalcohols” and “monothiols” are known to those skilled in the art as compounds having exclusively just one of the functional groups listed; these compounds are thus defined explicitly as having only one of the functional groups listed.

Preferably, the hydrocarbon has 6 to 30 carbon atoms, preferably 12 to 26, more preferably 14 to 20.

More preferably, the hydrocarbon has an uninterrupted chain of at least 6 carbon atoms, preferably from 6 to 21 carbon atoms.

Likewise more preferably, the hydrocarbon has one or more double bonds and/or triple bonds which may be isolated, conjugated or cumulated.

More preferably, the hydrocarbon has aromatic rings, preferably one or more benzene rings, one of the aromatic rings particularly preferably having the bonding site to component a).

For reaction of the biuret- and/or isocyanurate-containing polyisocyanates with reactive diluents to form the intermediates having component a) and component c), and also the intermediates with polymers bearing amine and/or hydroxyl groups to give the copolymers of the invention, it is preferable to speed up the reaction by catalysis. Catalysts used are the tin, bismuth and titanium catalysts well known to the skilled person from urethane chemistry, such as dibutyltin laurate, dioctyltin diketonate, dibutyltin dilaurate, dioctyltin dilaurate, available for example under the trade name TIB KAT® 216 (Goldschmidt TIB/TIB Chemicals), dibutyltin diacetylacetonate, dibutyltin diacetate, dibutyltin dioctoate, or dioctyltin diacetylacetonate, Borchi® catalysts, bismuth oxides, bismuth carboxylate, available for example under the trade name TIB KAT® 722 (Goldschmidt TIB/TIB Chemicals), bismuth methanesulphonate, bismuth nitrate, bismuth chloride, triphenylbismuth, bismuth sulphide, and also preparations comprising these catalysts, and titanates, e.g. titanium(IV) isopropoxide, iron(III) compounds, e.g. iron(III) acetylacetonate, and aluminium compounds, such as aluminium triisopropoxide, aluminium tri-sec-butoxide and other alkoxides and also aluminium acetylacetonate.

Also suitable, furthermore, are zinc salts, such as zinc octoate, zinc acetylacetonate and zinc 2-ethylcaproate, or tetraalkylammonium compounds, such as N,N,N-trimethyl-N-2-hydroxypropylammonium hydroxide, N,N,N-trimethyl-N-2-hydroxypropylammonium 2-ethylhexanoate, or choline 2-ethylhexanoate. Preference is given to using zinc octoate (zinc-2-ethylhexanoate), dioctyltin dilaurate, bismuth oxides, bismuth carboxylate, bismuth catalyst preparations and/or the tetraalkylammonium compounds, and particular preference to the use of zinc octoate, dioctyltin dilaurate and/or bismuth carboxylate, and also preparations with bismuth catalysts.

The catalyst is used preferably in concentrations of 5 to 5000 ppm. The amount in which the catalyst is used may considerably influence the composition of the end product. For different catalysts it may therefore be advisable to select different use concentrations. For example, organotin catalysts can be used preferably in concentrations of 5 to 150 ppm, and bismuth carboxylates preferably in concentrations of 300 to 2000 ppm. The concentration figures are based on the respective sum total of the co-reactants present, neglecting further unreactive constituents, for example solvents.

As a further component step for preparation of the polymer of the invention, a subsequent distillation/purification of the conversion products may be advantageous. The distillation/purification may be effected with the aid of a rotational evaporator for example, preferably at a temperature of 20° C. to 250° C., by preference 40° C. to 180° C. and particularly preferably 50° C. to 150° C. The pressure here is preferably 0.0001 to 0.75 bar, by preference more than 0.001 to 0.2 bar and particularly preferably 0.01 to 0.1 bar. The distillation/workup may in particular be advantageous for removing solvents.

The products of the process according to the invention may have structures lacking component b). Preferably, the products of the process include these products having only component a) and component c) to an extent of not more than 15% by weight, preferably to an extent of 0.01 percent to 10 percent by weight.

Compositions according to the invention also comprise, as well as the copolymers according to the invention or the process products according to the invention, additives which may be selected from the list comprising boosters, emulsifiers, solvents, perfume, perfume carriers, dyes, viscosity regulators, defoamers, preservatives, active antimicrobial ingredients, germicides, fungicides, antioxidants, organic solvents, non-siloxane-containing polymers and other noninventive siloxane-containing polymers, for example silicone oils, surfactants, builders, bleaches, bleach activators, enzymes, fluorescers, foam inhibitors, antiredeposition agents, optical brighteners, greying inhibitors, antishrink agents, anticrease agents, dye transfer inhibitors, corrosion inhibitors, antistats, bitter substances, ironing aids, repellency-imparting and impregnating agents, antiswell and antislip agents, neutral filler salts and UV absorbers. It is possible here for substances from one class also to display efficacy in another class.

Aqueous emulsions according to the invention also comprise, as well as the copolymers according to the invention or the process products according to the invention, additives which may be selected from the list in the preceding paragraph.

Preferred compositions according to the invention or aqueous emulsions according to the invention are especially concentrates, compound/emulsion concentrates and/or aqueous formulations, aqueous emulsions and/or solutions thereof, or a formulation or emulsion in organic compounds such as polyethers, polyols, alcohols.

More particularly, the compositions according to the invention may contain between 0.001% and 25% by weight, more preferably 0.01% to 15% by weight, based on the total mass of the fabric softener, of one or more different additives or auxiliaries.

Additionally particularly preferred compositions according to the invention are concentrates containing the copolymers according to the invention or the process products according to the invention in concentrations of about 90% to 99.99% by weight, based on the total mass of concentrate, to which only small proportions of solvents have been added. The concentrates are preferably not aqueous solutions.

Further particularly preferred compositions according to the invention are compound or emulsion concentrates containing the copolymers according to the invention or the process products according to the invention in concentrations of 40% to 90% by weight, preferably 50% to 80% by weight, based on the overall composition. Further constituents of these compositions are water and/or solvents selected from the group of the glycols, unbranched and/or branched alcohols and/or alkyl ethers having 1 to 6 carbon atoms and optionally one or more nonionic emulsifiers, for example an alcohol ethoxylate having 3-25 ethylene oxide units. Compound and emulsion concentrates are generally water-soluble or self-emulsifiable.

Particularly preferred aqueous emulsions according to the invention are fabric softeners for treatment of textile fabrics.

Especially preferred compositions according to the invention are fabric softeners for temporary or permanent finishing of textiles.

Fabrics in the context of this invention are solid or composed of fibers, such as wood, cotton, polyester, polyamide, synthetic fibers, paper and cardboard, viscose, cellulose and/or lignin-based fibers.

The fabrics are preferably selected from the group comprising woven fabrics, textile woven fabrics, loop-formed knits, loop-drawn knits, nonwovens, tissues (paper fibers) and/or fibers of natural and/or synthetic raw materials, leather, hair, fur and wood.

The compositions according to the invention may optionally comprise further textile softeners. These are one or more cationic textile-softening compounds having one or more long-chain alkyl groups in one molecule. Widely used cationic textile-softening compounds include, for example, methyl-N-(2-hydroxyethyl)-N,N-di(tallowacyloxyethyl)ammonium compounds or N,N-dimethyl-N,N-di(tallowacyloxyethyl)ammonium compounds. Further suitable ammonium compounds are disclosed by US 2010/0184634 in paragraphs [0027] to [0068], the explicit disclosure content of which in this regard is incorporated into this disclosure by this reference.

By dilution with water, it is possible, for example, to produce the fabric softeners according to the invention from the concentrates, emulsion concentrates and formulations according to the invention.

The aqueous emulsions according to the invention as softeners for textile fabrics contain the copolymers according to the invention or the process products according to the invention in proportions of 0.1% to 10% by weight, preferably 0.3% to 5% by weight, in particular 0.5% to 3% by weight, based on the overall formulation.

Emulsifiers used are typically fatty alcohol ethoxylates having ethoxylation levels between 3 and 12, specifically in a ratio of the copolymer to the fatty alcohol ethoxylate of 5:1 to 1:1. High-boiling glycols such as dipropylene glycol or butyl diglycol are also employed.

Preferably, emulsifiers are present in the compositions according to the invention and the aqueous emulsions according to the invention to an extent of 0.1% to 5% by weight, more preferably to an extent of 0.5% to 2% by weight.

As perfume it is possible to use all fragrances of fragrance mixtures that are known to be suitable for aqueous fabric softeners from the prior art, preferably in the form of a perfume oil. Examples of fragrances or scents are disclosed inter alia in DE 197 51 151 A1, page 4 lines 11-17. More particularly, the compositions according to the invention may contain between 0.01% and 10%, more preferably 0.1% to 5% by weight, of one or more fragrances or fragrance mixtures.

Dyes used may be any dyes known to be suitable for aqueous fabric softeners from the prior art, preference being given to water-soluble dyes. Examples of suitable water-soluble commercial dyes are SANDOLAN® Walkblau NBL 150 (manufacturer: Clariant) and Sicovit® Azorubin 85 E122 (manufacturer: BASF). More particularly, the compositions according to the invention may contain between 0.001% and 0.1% by weight, more preferably 0.002% to 0.05% by weight, of one or more dyes or dye mixtures.

As viscosity regulator for reducing the viscosity, the aqueous fabric softener may comprise an alkali metal or alkaline earth metal salt, preferably calcium chloride, in an amount of 0.05% to 2% by weight.

As viscosity regulator for increasing the viscosity, the aqueous fabric softener may comprise a thickener known to be suitable from the prior art, preference being given to the polyurethane thickeners known from WO 2007/125005. Examples of suitable thickeners are TEGO® Visco Plus 3030 (manufacturer: Evonik Tego Chemie), Acusol® 880 and 882 (manufacturer: Rohm & Haas), Rheovis® CDE (manufacturer: BASF), Rohagit® KF 720 F (manufacturer: Evonik Röhm GmbH) and Polygel® K100 from Neochem GmbH.

Defoamers used may be any defoamers known to be suitable for aqueous fabric softeners from the prior art. Examples of suitable commercial defoamers are Dow Corning® DB-110A and TEGO® Antifoam® 7001 XP. Preferably, the compositions according to the invention contain between 0.0001% and 0.05%, more preferably 0.001% to 0.01% by weight, of one or more different defoamers.

As preservative, the aqueous fabric softener may comprise active bactericidal and/or fungicidal ingredients known to be suitable from the prior art, preference being given to water-soluble active ingredients. Examples of suitable commercial bactericides are methylparaben, 2-bromo-2-nitropropane-1,3-diol, 2-methyl-4-isothiazolin-3-one and 5-chloro-2-methyl-4-isothiazolin-3-one. The aqueous fabric softener may likewise comprise an oxidation inhibitor as preservative. Examples of suitable commercial oxidation inhibitors are ascorbic acid, 2,6-di-tert-butyl-4-methylphenol (BHT), butylhydroxyanisole (BHA), tocopherol and propyl gallate. Preferably, the compositions according to the invention contain between 0.0001% and 0.5%, more preferably 0.001% to 0.2% by weight, of one or more different preservatives. More particularly, the compositions according to the invention may contain between 0.001% and 0.1%, more preferably 0.001% to 0.01% by weight, of one or more different oxidation inhibitors.

As organic solvent, the fabric softener may comprise short-chain alcohols, glycols and glycol monoethers, preference being given to ethanol, 2-propanol, propane-1,2-diol and dipropylene glycol. More particularly, the compositions according to the invention may contain between 0.1% and 10%, more preferably 0.2% to 5% by weight, of one or more different organic solvents.

The fabric softener may comprise one or more non-siloxane-containing polymers. Examples of these are carboxymethyl cellulose, polyethylene glycol, polyvinyl alcohol, poly(meth)acrylates, polyethyleneimines or polysaccharides. More particularly, the compositions according to the invention may contain between 0.01% and 25% by weight, more preferably 0.1% to 10% by weight, of one or more different non-siloxane-containing polymers.

Boosters in the context of the invention are compounds that bring about an additional improvement in water repellency on the treated fabrics. The boosters are capable of reacting in a crosslinking manner both with the free hydroxyl or amino functions of the copolymers according to the invention and with the textile fabrics. Preferred boosters have carbodiimide functions, particular preference being given to polycarbodiimides.

Preferred compositions according to the invention and aqueous emulsions according to the invention comprise at least one polycarbodiimide as booster.

Especially preferably, the compositions according to the invention and aqueous emulsions according to the invention, the copolymers according to the invention or the process products according to the invention comprise a polycarbodiimide as booster, at least one emulsifier, preservatives, optionally at least one solvent selected from ethyl acetate, butyl acetate, propylene glycol and TPM.

The invention further provides for the use of the copolymers according to the invention and of the process products according to the invention for finishing of fabrics.

Preference is given to the use for finishing of textile fabrics, more preferably in textile care compositions, especially in textile-softening compositions (fabric softeners).

Likewise preferred is the use of the copolymers according to the invention or of the process products according to the invention as coating compositions for wood.

Preferably, the copolymers according to the invention and the process products according to the invention are used as softeners for fabrics.

Preferred fabrics are selected from the group comprising textile woven fabrics, wood, leather, hair and fur, preference being given to woven textile fabrics, loop-formed knits, loop-drawn knits, nonwovens, tissue (paper fibers) and/or fibers made from natural and/or synthetic raw materials.

The present invention further provides a process for liquid- and soil-repellent impregnation of textile fabrics by using the copolymers according to the invention.

Within the scope of the present invention, repellency means that textile fabrics have been rendered repellent against liquids and soil, preferably water and aqueous solutions and/or oils and fats. Liquids in particular are at least partly repelled by the finish.

Repellency is preferably ascertained by ascertaining the respective contact angle (DIN EN ISO 14419) and/or through determination by a spray test according to AATCC M22-2014, as shown in the examples. An improvement in the contact angle is manifested by an increase in the contact angle or by slower soaking of the droplet into the material, i.e. an increase in the contact angle after a contact time, preferably 60 seconds after the application of the droplet. In the spray test, an increase in the value means an improvement. The assessments are made in comparison to an analogous treatment without active ingredient.

A preferred process for liquid- and soil-repellent impregnation of textile fabrics is use of the compositions according to the invention, preferably of the aqueous emulsions, more preferably of the aqueous emulsions with use of boosters, especially preferably of the aqueous emulsions with use of a polycarbodiimide as booster.

The invention further provides repellent textile fabrics comprising the copolymers according to the invention, preferably in combination with a booster, more preferably with a polycarbodiimide as booster, with retention of or improvement in the tactile properties.

The tactile properties are based on the hand, the hand preferably being determined with the aid of a TSA as described in the examples. Especially preferably, the hand is determined with a piece of textile fabric that has been cut to size, after prior conditioning (4 hours) at 25° C. and 50% relative air humidity, by inserting and clamping it into the TSA (Tissue Soft Analyzer, from Emtec Electronic GmbH). The test instrument then determines individual values for softness, smoothness and stiffness of the textile fabric and uses these to ascertain the overall impression, the handfeel (HF). This HF value was ascertained by means of an algorithm specially designed for textiles by EMTEC. A rising HF value means a higher softness. The assessments are made in comparison to an analogous treatment without active ingredient.

### WORKING EXAMPLES

General Methods and Materials

Determination of isocyanate content (proportion by mass of isocyanate groups) to EN ISO 11909:2007:

The starting weight is guided by the isocyanate content. If the approximate isocyanate content is unknown, it has to be ascertained in a preliminary experiment with a starting weight of 3.5 g of polymer. Weigh the sample accurately to 1 mg into a 500 ml Erlenmeyer flask and dissolve it in 25 ml of toluene, if necessary with gentle heating. After cooling to room temperature, add 20 ml of the appropriate dibutylamine solution with a pipette. Seal the flask and leave it to stand for 15 min, with occasional shaking. Dilute with 150 ml of ethanol and, after addition of a few drops of bromophenol blue solution, titrate with the appropriate hydrochloric acid until the color changes to yellow. If separation occurs during the titration, add additional ethanol.

GPC:

GPC measurements for determining the polydispersity and weight-average molar masses Mw were carried out under the following measurement conditions: Column combination SDV 1000/10 000 A (length 55 cm), temperature 35° C., THF as mobile phase, flow rate 0.35 ml/min, sample concentration 10 g/1, RI detector, polymers according to the invention evaluated against polystyrene standard (162-2 520 000 g/mol).

Materials:

Unidyne TG-580: a fluoroalkyl acrylate as aqueous emulsion, content 30% by weight;

Vestanat® HT 2500/LV (trademark of Evonik, Germany) an aliphatic polyisocyanate based on hexamethylene diisocyanate with an NCO value of 22.8%; it contains isocyanurate structures and has an NCO functionality between 3 and 4;

Vestanat® T 1890/100: an aliphatic polyisocyanate based on isophorone diisocyanate with an NCO value of 17.2%; it contains isocyanurate structures and has an NCO functionality between 3 and 4;

Vestanat® HB 2640 LV: an aliphatic polyisocyanate based on hexamethylene diisocyanate with an NCO value of 22.8%; it contains biuret and has an NCO functionality between 3 and 4;

Novares® LS 500: (trademark of RUTGERS Novares, Germany) a reaction product of styrene with phenol having an average of 1.5 styrene units per phenol; the product has an OHN of 242.7;

TIB Kat 716 (from TIB Chemicals AG);

isostearyl alcohol with an OHN of 203.5 from Falc; stearyl alcohol (97% by weight), from ABCR; myristyl alcohol (>96%), Kao Chemicals; cetyl alcohol (>98%), Evonik; lauryl alcohol (98% by weight), from Aldrich;

Polyvest® EP HT: (trademark of Evonik) a hydroxy-terminated polybutadiene having an OHN of 47 mg KOH/g; α,ω-dihydroxypolydimethylsiloxane, OHN 51, 30 siloxane units; α,ω-dihydroxypolydimethylsiloxane, OHN 14, 80 siloxane units; tris-terminal trihydroxypolydimethylsiloxane, OHN 35, formula (I) M₃D₅₇T₁Q₀; terminal aminopolydimethylsiloxane with a nitrogen content of 3.1% by weight, 10 siloxane units;

PM 3705 is a polycarbodiimide from 3M, 25% by weight in propylene glycol/water (8%/67%);

Synperonic PE/F 108: an ethoxylated polypropylene oxide having a molar mass of about 14 000 g/mol;

Acticide MBS, an aqueous 5% by weight preservative, mixture of two isothiazolinone biocides, from Thor;

n-butyl acetate (98% by weight) from Brenntag; ethyl acetate (99.5%) from Sigma-Aldrich; Dowanol TPM: a tripropylene glycol monomethyl ether, from DOW;

Fabric:

Textiles: cotton, woven fabric: basis weight 205 g/m², thickness: 400 μm; polyester: basis weight 170 g/m², thickness: 200 μm; polyamide: basis weight 65 g/m², thickness: 50 μm, all samples from WFK-Testgewebe GmbH (Christenfeld 10 41379 Bruggen);

Wood: natural beech, 5.0×5.0 cm test plaques, from Rocholl GmbH.

### Example 1, Synthesis Examples, a) Isocyanurates

### Example 1a.1

A heatable glass flask with mechanical stirrer, thermometer and gas inlet was initially charged with 552.63 g of Vestanat HT 2500 LV and heated to 50° C. 463 g of Novares LS 500 and 423.41 g of n-butyl acetate and 1000 ppm of TIB Kat 716 were added dropwise within 90 min. (This amount of catalyst, in all examples, is based on the sum total of the isocyanate compounds and the respective component c)). The reaction temperature was kept at 50° C. for 3 hours. Thereafter, the NCO value was determined using a sample taken.

As expected, 2/3 of the NCO groups had been converted. The temperature was increased to 70° C., 1111 g of a hydroxysiloxane with OHN 51 mg KOH/g and 100 ppm of TIB Kat LA 716 were added within 5 minutes, the temperature was increased to 80° C. and the mixture was stirred for a further 2 hours. After cooling to room temperature, complete conversion of the remaining NCO groups was checked using a final sample.

GPC: Mw: 38832 g/mol; Mn: 20373 g/mol; Mw/Mn: 1.91.

### Example 1a.2

In an analogous experimental setup and with the same experimental procedure as in 1a.1, 22.1 g of Vestanat HT 2500 LV were reacted with 18.5 g of Novares LS 500 in 40.3 g of n-butyl acetate with 1000 ppm of TIB Kat 716. 2/3 of the NCO groups had been converted. The temperature was increased to 70° C., 161.9 g of a hydroxysiloxane with OHN 14 mg KOH/g and 100 ppm of TIB Kat LA 716 were added within 3 minutes, the temperature was increased to 80° C. and the mixture was stirred for a further 2 hours. Checking of conversion as in 1a.1.

GPC: Mw: 30.919 g/mol; Mn: 5308 g/mol; Mw/Mn: 5.82.

### Example 1a.3

In an analogous experimental setup and with the same experimental procedure as in 1a.1, 66.3 g of Vestanat HT 2500 LV were reacted with 66.1 g of isostearyl alcohol in 53 g of n-butyl acetate with 1000 ppm of TIB Kat 716. 2/3 of the NCO groups had been converted. The temperature was increased to 70° C., 133.32 g of a hydroxysiloxane with OHN 51 mg KOH/g and 100 ppm of TIB Kat LA 716 were added within 3 minutes, the temperature was increased to 80° C. and the mixture was stirred for a further 2 hours. Checking of conversion as in 1a.1.

GPC: Mw: 27081 g/mol; Mn: 9237 g/mol; Mw/Mn: 2.93.

### Example 1a.4

In an analogous experimental setup and with the same experimental procedure as in 1a.1, 77.36 g of Vestanat HT 2500 LV were reacted with 64.9 g of Novares LS 500 in 47.74 g of n-butyl acetate with 1000 ppm of TIB Kat 716. 2/3 of the NCO groups had been converted. The temperature was increased to 70° C., 168.7 g of a Polyvest® EP HT with OHN 47 mg KOH/g and 30 g of n-butyl acetate and 100 ppm of TIB Kat LA 716 were added within 3 minutes, the temperature was increased to 80° C. and the mixture was stirred for a further 2 hours. Checking of conversion as in 1a.1.

GPC: Mw: 84560 g/mol; Mn: 3830 g/mol; Mw/Mn: 22.08.

### Example 1a.5

In an analogous experimental setup and with the same experimental procedure as in 1a.1, 33.2 g of Vestanat HT 2500 LV were reacted with 16.7 g of Novares LS 500 and 13.0 g of stearyl alcohol in 203.76 g of ethyl acetate with 1000 ppm of TIB Kat 716. 2/3 of the NCO groups had been converted. The temperature was increased to 70° C., 242.8 g of a hydroxysiloxane with OHN 14 mg KOH/g and 100 ppm of TIB Kat LA 716 were added within 3 minutes, the temperature was increased to 80° C. and the mixture was stirred for a further 2 hours. Checking of conversion as in 1a.1.

GPC: Mw: 27940 g/mol; Mn: 6183 g/mol; Mw/Mn: 4.52.

### Example 1a.6

In an analogous experimental setup and with the same experimental procedure as in 1a.1, 71.8 g of Vestanat HT 2500 LV were reacted with 36.16 g of Novares LS 500 and 28.1 g of stearyl alcohol in 187 g of ethyl acetate with 1000 ppm of TIB Kat 716. 2/3 of the NCO groups had been converted. The temperature was increased to 70° C., 144.43 g of a hydroxysiloxane with OHN 51 mg KOH/g and 100 ppm of TIB Kat LA 716 were added within 3 minutes, the temperature was increased to 80° C. and the mixture was stirred for a further 2 hours. Checking of conversion as in 1a.1.

GPC: Mw: 31774 g/mol; Mn: 17612 g/mol; Mw/Mn: 1.8.

### Example 1a.7

In an analogous experimental setup and with the same experimental procedure as in 1a.1, 60.7 g of Vestanat HT 2500 LV were reacted with 59.5 g of stearyl alcohol in 161 g of n-butyl acetate with 1000 ppm of TIB Kat 716. 2/3 of the NCO groups had been converted. The temperature was increased to 70° C., 122.21 g of a hydroxysiloxane with OHN 51 mg KOH/g and 100 ppm of TIB Kat LA 716 were added within 3 minutes, the temperature was increased to 80° C. and the mixture was stirred for a further 2 hours. Checking of conversion as in 1a.1.

GPC: Mw: 21425 g/mol; Mn: 8923 g/mol; Mw/Mn: 2.40.

### Example 1a.8

In an analogous experimental setup and with the same experimental procedure as in 1a.1, 18.8 g of Vestanat HT 2500 LV were reacted with 18.4 g of stearyl alcohol in 116.46 g of ethyl acetate with 1000 ppm of TIB Kat 716. 2/3 of the NCO groups had been converted. The temperature was increased to 70° C., 137.5 g of a hydroxysiloxane with OHN 14 mg KOH/g and 100 ppm of TIB Kat LA 716 were added within 3 minutes, the temperature was increased to 80° C. and the mixture was stirred for a further 2 hours. Checking of conversion as in 1a.1. After cooling to room temperature, the product was solid.

GPC: Mw: 19466 g/mol; Mn: 4558 g/mol; Mw/Mn: 4.21.

### Example 1a.9

In an analogous experimental setup and with the same experimental procedure as in 1a.1, 55.26 g of Vestanat HT 2500 LV were reacted with 55.4 g of Novares LS 500 in 73 g of ethyl acetate with 1000 ppm of TIB Kat 716. 2/3 of the NCO groups had been converted. The temperature was increased to 70° C., 97.73 g of a hydroxysiloxane with OHN 35 mg KOH/g and 100 ppm of TIB Kat LA 716 were added within 3 minutes, the temperature was increased to 80° C. and the mixture was stirred for a further 2 hours. Checking of conversion as in 1a.1.

GPC: Mw: 36900 g/mol; Mn: 15300 g/mol; Mw/Mn: 2.4.

### Example 1a.10

A heatable glass flask with mechanical stirrer, thermometer and gas inlet was initially charged with 27.63 g of Vestanat HT 2500 LV and 23.1 g of Novares LS 500, and 70.91 g of ethyl acetate and 1000 ppm of TIB Kat 716 were added. The reaction temperature was kept at 50° C. for 3 hours. Thereafter, the NCO value was determined using a sample taken. As expected, 2/3 of the NCO groups had been converted. The temperature was increased to 70° C., 55.5 g of a hydroxysiloxane with OHN 51 mg KOH/g and 100 ppm of TIB Kat LA 716 were added within 3 minutes, the temperature was increased to 80° C. and the mixture was stirred for a further 3 hours. The reaction was ended and complete conversion of the remaining NCO groups was checked using a final sample.

GPC: Mw: 50700 g/mol; Mn: 23000 g/mol; Mw/Mn: 2.2.

### Example 1a.11

In an analogous experimental setup to that in 1a.1, 27.63 g of Vestanat HT 2500 were initially charged and 23.1 g of Novares LS 500 and 55.5 g of a hydroxysiloxane with OHN 51 mg KOH/g in 70.91 g of ethyl acetate with 1000 ppm of TIB Kat 716 were added at room temperature and the mixture was then heated. The reaction temperature was kept at 50° C. for 1 hour, then at 80° C. for 3 h. The reaction was ended and complete conversion of the remaining NCO groups was checked using a final sample.

GPC: Mw: 37800 g/mol; Mn: 19800 g/mol; Mw/Mn: 1.9.

### Example 1a.12

In an analogous experimental setup and with the same experimental procedure as in 1a.1, 55.3 g of Vestanat HT 2500 LV were reacted with 44.0 g of myristyl alcohol in 140.2 g of ethyl acetate with 500 ppm of TIB Kat 716. 2/3 of the NCO groups had been converted. The temperature was increased to 70° C., 111.1 g of a hydroxysiloxane with OHN 51 mg KOH/g and 100 ppm of TIB Kat LA 716 were added within 3 minutes, the temperature was increased to 80° C. and the mixture was stirred for a further 2 hours. Checking of conversion as in 1a.1. After cooling to room temperature, the product was solid.

GPC: Mw: 18400 g/mol; Mn: 8600 g/mol; Mw/Mn: 2.1.

### Example 1a.13

In an analogous experimental setup and with the same experimental procedure as in 1a.1, 55.3 g of Vestanat HT 2500 LV were reacted with 48.6 g of cetyl alcohol in 193.3 g of ethyl acetate with 500 ppm of TIB Kat 716. 2/3 of the NCO groups had been converted. The temperature was increased to 70° C., 111.1 g of a hydroxysiloxane with OHN 51 mg KOH/g and 100 ppm of TIB Kat LA 716 were added within 3 minutes, the temperature was increased to 80° C. and the mixture was stirred for a further 2 hours. Checking of conversion as in 1a.1. After cooling to room temperature, the product was solid.

GPC: Mw: 24800 g/mol; Mn: 10000 g/mol; Mw/Mn: 2.5.

### Example 1a.14

In an analogous experimental setup and with the same experimental procedure as in 1a.1, 73.3 g of Vestanat T 1890/100 were reacted with 46.3 g of Novares LS 500 in 154 g of ethyl acetate with 500 ppm of TIB Kat 716. 2/3 of the NCO groups had been converted. The temperature was increased to 70° C., 111.1 g of a hydroxysiloxane with OHN 51 mg KOH/g and 100 ppm of TIB Kat LA 716 were added within 3 minutes, the temperature was increased to 80° C. and the mixture was stirred for a further 2 hours. Checking of conversion as in 1a.1.

GPC: Mw: 40200 g/mol; Mn: 2700 g/mol; Mw/Mn: 14.8.

### Example 1a.15

In an analogous experimental setup and with the same experimental procedure as in 1a.1, 55.3 g of Vestanat HT 2500 LV were reacted with 46.3 g of Novares LS 500 in 128.5 g of ethyl acetate with 1000 ppm of TIB Kat 716. 2/3 of the NCO groups had been converted. The temperature was increased to 60° C., and 45.6 g of an aminosiloxane having a nitrogen content of 3.1% by weight were added within 3 minutes and the mixture was stirred at 70° C. for a further 2 hours. Checking of conversion as in 1a.1.

GPC: Mw: 3300 g/mol; Mn: 860 g/mol; Mw/Mn: 3.9.

### Example 1a.16

In an analogous experimental setup and with the same experimental procedure as in 1a.1, 55.3 g of Vestanat HT 2500 LV were reacted with 38.3 g of lauryl alcohol in 136.4 g of ethyl acetate with 500 ppm of TIB Kat 716. 2/3 of the NCO groups had been converted. The temperature was increased to 70° C., 111.1 g of a hydroxysiloxane with OHN 51 mg KOH/g and 100 ppm of TIB Kat LA 716 were added within 3 minutes, the temperature was increased to 80° C. and the mixture was stirred for a further 2 hours. Checking of conversion as in 1a.1. After cooling to room temperature, the product was solid.

GPC: Mw: 18200 g/mol; Mn: 8500 g/mol; Mw/Mn: 2.2.

### Example 1a.17

In an analogous experimental setup and with the same experimental procedure as in 1a.1, 55.3 g of Vestanat HT 2500 LV were reacted with 3.8 g of lauryl alcohol and 39.6 g of myristyl alcohol in 139.8 g of ethyl acetate with 500 ppm of TIB Kat 716. 2/3 of the NCO groups had been converted. The temperature was increased to 70° C., 111.1 g of a hydroxysiloxane with OHN 51 mg KOH/g and 100 ppm of TIB Kat LA 716 were added within 3 minutes, the temperature was increased to 80° C. and the mixture was stirred for a further 2 hours. Checking of conversion as in 1a.1. After cooling to room temperature, the product was solid.

GPC: Mw: 18500 g/mol; Mn: 8400 g/mol; Mw/Mn: 2.2.

### Example 1, Synthesis Examples, b) Biuret

### Example 1b.1

In an analogous experimental setup and with the same experimental procedure as in 1a.1, 57.3 g of Vestanat HB 2640 LV were reacted with 46.3 g of Novares LS 500 in 143.1 g of ethyl acetate with 1000 ppm of TIB Kat 716. 2/3 of the NCO groups had been converted. The temperature was increased to 70° C., 111.1 g of a hydroxysiloxane with OHN 51 mg KOH/g and 100 ppm of TIB Kat LA 716 were added within 3 minutes, the temperature was increased to 80° C. and the mixture was stirred for a further 4 hours. Checking of conversion as in 1a.1.

GPC: Mw: 13300 g/mol; Mn: 1300 g/mol; Mw/Mn: 10.5.

### Example 2, Application Examples

### Example 2.1; Formulation and Finishing

The emulsifying of the active ingredients was conducted by 2 different methods as follows:

Method 1: 6% to 8% of the amount of water was initially charged together with emulsifiers and dissolved. The active ingredient was incorporated gradually at a high shear rate with a mizer disc (2000 rpm, corresponding to peripheral speed about 8 m/s) and with cooling. Stirring was continued at high shear rate under reduced pressure for 15 min. With decreasing shear rate, the mixture was diluted with water, then Acticide MBS preservative was added, and the mixture was filtered through a 190 μm fast sieve and dispensed.

Method 2: Diluting with organic solvent (e.g. ethyl acetate, butyl acetate) according to the active ingredient concentrations in the table below, followed by application to the fabric.

As an alternative to Methods 1 and 2 as detailed, the emulsification of the active ingredients can also be effected using an ultrasonic homogenizer or a slot homogenizer in a manner known to the person skilled in the art.

TABLE 1
Compositions of the formulations for application to textiles and wood,
FIGURES in % by weight, * relates to the compositions of Table 3

| | *.1 | *.3 | *.4 | *.5 | *.6 | *.7 | *.2 | 4.2 | 4.3 |
|---|---|---|---|---|---|---|---|---|---|
| 1a.1 | | 40 | | | 20 | 20 | 2.0 | 8.8 | 8.8 |
| 1a.2 | | | 41.7 | | | | | | |
| 1a.3 | | | | 41.7 | | | | | |
| PCDI | | | | | 12.5 | 12.5 | | | |
| TG-580 | 30 | | | | | | | | |
| (active | | | | | | | | | |
| ingredient) | | | | | | | | | |
| Syn- | | 3 | 3 | 3 | 1.5 | 1.5 | | | |
| peronic | | | | | | | | | |
| PE/F 108 | | | | | | | | | |
| Acticide | | 0.25 | 0.25 | 0.25 | 0.13 | 0.13 | | | |
| MBS | | | | | | | | | |
| Butyl | | 10 | 8.3 | 8.3 | 5.0 | | 98.0 | 91.2 | |
| acetate | | | | | | | | | |
| Ethyl | | | | | | | | | 91.2 |
| acetate | | | | | | | | | |
| Dowanol | | | | | | 5.0 | | | |
| TPM | | | | | | | | | |
| Propylene | | | | | 4 | 4 | | | |
| glycol | | | | | | | | | |
| Water | 70 | 46.75 | 46.75 | 46.75 | 56.87 | 56.87 | | | |
| Method | | 1 | 1 | 1 | 1 | 1 | 2 | 2 | 2 |

Padding method (model: HVF, Mathis AG):

To test the respective emulsions, a liquor that contained 8 g/l of the appropriate emulsion in each case was applied to cotton fabric (205 g/m²), polyamide fabric (65 g/m²) and polyester fabric (170 g/m²), which were squeezed off to a wet pickup of about 70%-80% by weight and dried. The values employed for pressure and speed can be found in Table 2. Padding application took place at room temperature.

TABLE 2
Pressures and roll speeds used in the padding method.

| Name | Pressure [bar] | Speed [m/min] |
|---|---|---|
| Cotton fabric | 5.4 | 2 |
| Polyester fabric | 1.0-1.2 | 2 |
| Polyamide fabric | 1.0 | 1-2 |

Exhaust Process Starting from Solvent-Containing Formulations:

To test the respective copolymers according to the invention (active ingredients), knitted cotton fabric (205 g/m²), polyamide (65 g/m²) and polyester (170 g/m²) were finished with a liquor that contained 20 g/l of the appropriate active ingredient in each case. A liquor ratio (fabric to liquor) of 1:15 was chosen. Solvents used are water, butyl acetate and ethyl acetate. The test fabric is treated in the liquor with continuous agitation on the reciprocating shaker (model: 3006, manufacturer: GFL) for 30 min. After 30 min, the test fabric is removed from the bath, wrung out gently, shaken and dried. A blank is treated under the same conditions with demineralized water only.

Drip Method (Wood Application):

The application of the copolymers according to the invention (active ingredients) to the wood surface proceeded as follows: a solution of the active ingredient (9%, active content) in ethyl acetate, butyl acetate or water was distributed homogeneously over the surface of the wood plaque (dimensions: 5 cm×5 cm) with the aid of a syringe such that each plaque was coated with 45 mg of the active ingredient. The blank was determined using an untreated wood plaque. The fluorinated reference product was diluted in water, such that the concentration of the active content was 90 g/l. The plaques were left to flash off at room temperature and then dried and fixed as described below. The application and analysis of the droplets on the surface proceeded analogously to the experiments with textiles.

Drying Method (LTE Lab Dryer, Mathis AG, Ventilator Speed 2000 Rpm):

The fabrics were dried at 105° C. (plus dwell time, i.e. the heating time of the textile fabric) for 2 min and then condensed at 160-180° C. (without dwell time) for 0.5-1 min in order to fix the finish. Exact conditions:

| | Drying | | Fixing | |
|---|---|---|---|---|
| | [° C.] | [min] | [° C.] | [min] |
| Cotton fabric (exhaust) | 105 | 2.0 | 160 | 1.0 |
| Polyester fabric (exhaust) | 105 | 2.0 | 180 | 0.5 |
| Polyamide fabric (exhaust) | 105 | 2.0 | 180 | 0.5 |
| Cotton fabric (padding) | 105 | 2.0 | 150 | 3.0 |
| Polyester fabric (padding) | 105 | 2.0 | 150 | 3.0 |
| Polyamide fabric (padding) | 105 | 2.0 | 150 | 3.0 |
| Wood | 105 | 2 | 180 | 0.5 |

### Example 2.2; Testing of the Finish

Method of Contact Angle Measurement (Surftens Universal, OEG-GmbH) on Textiles

In accordance with ISO/DIN 19403-6 and DIN EN ISO 14419, water repellency/oil repellency was tested as follows: The textiles were finished by means of padding application or the exhaust method, dried and fixed. The wood plaques were likewise finished as described above. The finished textile specimens were mounted in an embroidery frame of diameter about 8 cm. They thus formed a surface sufficiently smooth for contact angle measurement. The tension ring with the textile fabric was placed onto the measurement stage of the contact angle measuring instrument and focused. This was unnecessary for analysis of the wood plaques; these were usable as they were. For determination of hydrophilicity, one droplet of water was then applied to the textile fabric. It is crucial here that the droplet falls onto the textile fabric from a low and constant height. Application by means of an Eppendorf pipette has been found to be optimal, with a fixed droplet volume of 15 μl of demineralized (DM) water. After the droplet had been applied, the contact angle was determined continuously by means of multipoint analysis. This involved marking the edge of the droplet and simulating the shape of the droplet. This operation was conducted by image analysis immediately after application of the droplet (“0” seconds), after 5, 15, 30, 60, 120, 180, 240 and 300 seconds. It was thus possible to illustrate the soaking-in characteristics of the droplet over 5 minutes. For determination of oleophobicity, in an analogous manner to that described above, a droplet of 20 μl of white oil (Sigma Aldrich (M8410), CAS 8042-47-5, Brookfield viscosity at 25° C.: 25.0 cps, density: 0.86 g/cm³) was applied. The behavior with respect to the specimen was documented as described above. In both test modes, the contact angle was plotted against the respective time, by means of which it is possible to immediately recognize hydrophobicity or oleophobicity from the graph. The blank used was appropriately an unfinished specimen. If the contact angle decreases over time, the droplets soaks in; it remains constant, there is adequate repellency. In addition, the Y-axis intercept enables a further distinction. The greater the contact angle, the greater the repellent action of the textile finish applied.

Spray Test

In accordance with ISO 9073-17 or according to AATCC method 22-2014, water repellency was evaluated by the sprinkling test (dynamic water repulsion). For this purpose, a fabric section or part of an item of clothing on an oblique plane was sprinkled with 250 ml of water by means of a sprinkler from a height of 15 cm and then the image of the adhering water was assessed. A scale from 0 to 100 was used for the purpose, with 0 meaning complete wetting and 100 meaning no wetting at all.

Hand

Hand is a fundamental quality parameter of a fabric. It can be described by, for example, smoothness, compressibility and stiffness. Normally, hand is determined by subjective assessment via manual testing. In addition, there are measuring instruments for the purpose that determine it objectively.

A piece of textile fabric that has been cut to size, after prior conditioning (4 hours) at 25° C. and 50% relative air humidity, was inserted and clamped into the TSA (Tissue Soft Analyzer, from Emtec Electronic GmbH). The test instrument then determines individual values for softness, smoothness and stiffness of the textile fabric and uses these to ascertain the overall impression, the handfeel (HF). This HF value was ascertained by means of an algorithm specially designed for textiles by EMTEC.

Wash Test:

In accordance with DIN EN ISO 6330, washing resistance was determined by washing the textile fabric in a standard domestic washing machine (Novotronic W918 fully automatic washing machine, Miele). For this purpose, a standard detergent of the IEC A* type (according to IEC 60456, *no phosphate, manufacturer: WFK-Testgewebe GmbH) was used. In addition, 3 kg of cotton fabric were added to the wash as ballast material. Programme: hot/colored wash 40° C., 19 g of detergent, duration of a wash cycle: 2:02 h, spin speed: 1200 rpm.

Application test results:

TABLE 3
The following samples were tested on cotton (1.1 to 1.8), on polyester
(2.1 to 2.8), on polyamide (3.1 to 3.8) and on wood (4.1 to 4.4);
elucidation of the sample numbers (after the point) as shown in Table 1.

| Sample | No. | | | |
|---|---|---|---|---|
| TG-580 | 1.1 | 2.1 | 3.1 | 4.1 |
| 1a.1 (exhaust) | 1.2 | 2.2 | 3.2 | |
| 1a.1 (padding) | 1.3 | 2.3 | 3.3 | |
| 1a.1 in butyl acetate | | | | 4.2 |
| 1a.1 in ethyl acetate | | | | 4.3 |
| 1a.2 (padding) | 1.4 | 2.4 | 3.4 | |
| 1a.3 (padding) | 1.5 | 2.5 | 3.5 | |
| Mixture of 1a.1/PCDI (in BuAc) | 1.6 | 2.6 | 3.6 | |
| Mixture of 1a.1/PCDI (in TPM) | 1.7 | 2.7 | 3.7 | |
| Blank | 1.8 | 2.8 | 3.8 | 4.4 |

TABLE 4
Results of the contact angle measurements and of the spray test for cotton:
Before washing

| | Contact angle for water | | Spray | Contact angle for oil | |
|---|---|---|---|---|---|
| No. | 0 sec | 60 sec | test | 0 sec | 60 sec |
| 1.1 | 130.6 | 128 | 50 | 120.5 | 122.9 |
| 1.2 | 127.8 | 127.4 | 90 | 81.5 | 0 |
| 1.3 | 106.3 | 95.3 | 60 | 60.5 | 0 |
| 1.4 | 117.2 | 114.6 | 80 | 77 | 0 |
| 1.5 | 100.7 | 0 | 0 | 81.7 | 0 |
| 1.6 | 125.0 | 123.8 | 75 | 64.9 | 0 |
| 1.7 | 131 | 132.1 | 80 | 80.8 | 0 |
| 1.8 | 0 | 0 | 0 | 27.8 | 0 |

After washing

| | Contact angle for water | | Spray | Contact angle for oil | |
|---|---|---|---|---|---|
| No. | 0 sec | 60 sec | test | 0 sec | 60 sec |
| 1.1 | 88.9 | 0 | 0 | 72.3 | 0 |
| 1.2 | 103.9 | 78.4 | n.d. | 66.5 | 0 |
| 1.3 | 101.7 | 93.4 | 75 | 67.8 | 0 |
| 1.4 | 104.7 | 0 | 60 | 87.6 | 0 |
| 1.5 | 98.3 | 0 | 0 | 73.4 | 0 |
| 1.6 | 111.1 | 109.8 | 85 | 64.1 | 0 |
| 1.7 | 126.6 | 123.6 | 80 | 64.5 | 0 |
| 1.8 | 0 | 0 | 0 | 32.2 | 0 |

As shown in Table 4, the copolymers according to the invention almost achieve the water repellency of the fluorinated comparative product (1.1), or even exceed it after washing, as shown particularly clearly by the samples comprising the copolymer from synthesis example 1a.1 (1.2, 1.3, 1.6 and 1.7).

TABLE 5
Results of the contact angle measurements and of the spray test for polyester:
Before washing

| | Contact angle for water | | Spray | Contact angle for oil | |
|---|---|---|---|---|---|
| No. | 0 sec | 60 sec | test | 0 sec | 60 sec |
| 2.1 | 130.6 | 129.5 | 100 | 125.3 | 124.2 |
| 2.2 | 128.9 | 125.9 | 90 | 71.3 | 22.5 |
| 2.3 | 138.4 | 135.1 | 80 | 98 | 22.5 |
| 2.4 | 131.2 | 127.8 | 70 | 79 | 0 |
| 2.5 | 127.5 | 127 | 70 | 84.1 | 0 |
| 2.6 | 123.9 | 122.9 | 90 | 74.6 | 29.9 |
| 2.7 | 132.2 | 132.8 | 85 | 82.1 | 25.5 |
| 2.8 | 112.9 | 113.9 | 75 | 48.7 | 0 |

After washing

| | Contact angle for water | | Spray | Contact angle for oil | |
|---|---|---|---|---|---|
| No. | 0 sec | 60 sec | test | 0 sec | 60 sec |
| 2.1 | 129.6 | 129 | 80 | 121 | 119.9 |
| 2.2 | 128.8 | 130.3 | 80 | 89.7 | 39.7 |
| 2.3 | 129.8 | 128.9 | 80 | 86.1 | 30.6 |
| 2.4 | 124.9 | 124.4 | 80 | 79.9 | 0 |
| 2.5 | 122.4 | 121.9 | 50 | 83.1 | 0 |
| 2.6 | 128.6 | 126.6 | 85 | 94.5 | 38.4 |
| 2.7 | 131.3 | 131.6 | 80 | 88.9 | 26.2 |
| 2.8 | 87.1 | 0 | 0 | 44.3 | 0 |

As apparent from Table 5, the copolymers according to the invention surpassed the water repellency of the fluorinated comparative product. As shown particularly clearly by Examples 2.2 and 2.3, adequate oil repellency is also achieved. Adequate oil repellency means in particular that the contact angle immediately after application is much greater than for the untreated material sample and that, especially after 60 sec, the oil has preferably not completely soaked in.

TABLE 6
Results of the contact angle measurements and of the spray test for polyamide:
Before washing

| | Contact angle for water | | Spray | Contact angle for oil | |
|---|---|---|---|---|---|
| No. | 0 sec | 60 sec | test | 0 sec | 60 sec |
| 3.1 | 127.3 | 126.4 | 100 | 110 | 110.4 |
| 3.2 | 118.5 | 118 | 90 | 99.1 | 99 |
| 3.3 | 109.4 | 109.4 | 90 | 102.5 | 103.7 |
| 3.4 | 110.7 | 109.6 | 85 | 94.6 | 89.6 |
| 3.5 | 114.7 | 111.9 | 80 | 96.8 | 95.6 |
| 3.6 | 111.7 | 109.1 | 95 | 97.1 | 98.5 |
| 3.7 | 110.5 | 108.5 | 85 | 92.7 | 92.5 |
| 3.8 | n.d. | n.d. | n.d. | n.d. | n.d. |

After washing

| | Contact angle for water | | Spray | Contact angle for oil | |
|---|---|---|---|---|---|
| No. | 0 sec | 60 sec | test | 0 sec | 60 sec |
| 3.1 | 108.7 | 107.2 | 90 | 94.4 | 93.8 |
| 3.2 | 96.8 | 95.8 | 80 | 96.2 | 81.2 |
| 3.3 | 105.1 | 105.3 | 80 | 96.7 | 95.6 |
| 3.4 | 108.6 | 108.1 | 80 | 92.1 | 71.5 |
| 3.5 | 108 | 106.9 | 80 | 98.7 | 70.3 |
| 3.6 | 104.8 | 104.8 | 90 | 88.2 | 87.6 |
| 3.7 | 102.1 | 102.6 | 80 | 84.7 | 80.9 |
| 3.8 | 89.6 | 86.5 | 70 | 89.2 | 85.2 |

As presented in Table 6, the copolymers according to the invention surprisingly surpassed both the water repellency and oil repellency of the fluorinated comparative product. As shown by Example 3.3, excellent water and oil repellency was achieved both before and after washing.

TABLE 7
Results of the contact angle measurements for wood:

| | Contact angle for water | | Contact angle for oil | |
|---|---|---|---|---|
| No. | 0 sec | 60 sec | 0 sec | 60 sec |
| 4.1 | 129.7 | 125.1 | 96.7 | 96.7 |
| 4.2 | 85.8 | 85.5 | 58.9 | 57.8 |
| 4.3 | 86.2 | 85.9 | 59.4 | 58.2 |
| 4.4 | 59.7 | 32.5 | 36.1 | 9.9 |

As shown in Table 7, the active ingredient according to the invention brought about a water and oil repellency, such that the respective water/oil droplets did not spread across the wood.

TABLE 8
Handfeel values for the textile fabrics (without washing):

| | Handfeel | | |
|---|---|---|---|
| | Cotton | Polyester | Polyamide |
| *.1 | 47.6 | 58.6 | 50.8 |
| *.3 | 49.2 | 60.5 | 69.8 |
| *.4 | 47.9 | 62.5 | 76 |
| *.5 | 47.8 | 61.5 | 69.3 |
| *.6 | 48 | 60.7 | 67.6 |
| *.8 | 47.7 | 61.8 | 50.8 |

As indicated in Table 8, the active ingredients according to the invention caused a perceptibly better handfeel of the materials than the fluorinated comparative sample. The samples comprising the active ingredient from Example 1a.1 were the best on cotton fabric, whereas the copolymer from Example 1a.2 brought about the clearest improvement in handfeel on synthetic fibers.

1. A copolymer comprising three components:
component a) having a biuret or isocyanurate substructure,
component b) selected from the group consisting of polysiloxanes and polyhydrocarbons,
component c) comprising a hydrocarbon which is different from component b) and has at least 6 carbon atoms and not more than 3 heteroatoms selected from the group consisting of N, O, S,
wherein component b) is joined to 2 different or identical components a) via at least two positions.

2. The copolymer according to claim 1 wherein component b) is a polybutadiene.

3. The copolymer according to claim 1 are free of halogen atoms and are free of polyether structures.

4. The copolymer according to claim 1 have component a) and component c) in a ratio of number of c) divided by number of a) of 1 to 3.

5. The copolymer according to claim 1 each have, in component a), two or more biuret or isocyanurate substructures.

6. The copolymer according to claim 1 have, as component a), independently identical or different biuret substructures of the formula (III) and isocyanurate substructures of the formula (IV) 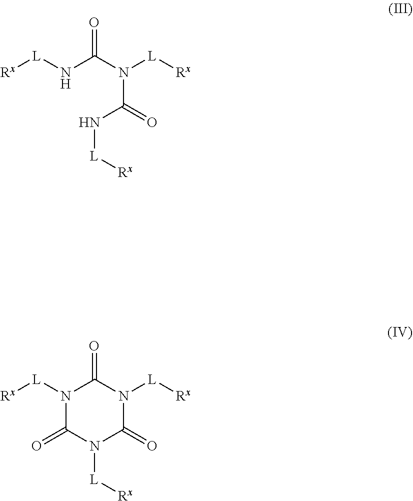
in which
L is divalent radicals of tolyl (2,4-; 2,6-), ethylphenyl, 1,5-naphthyl, α,ω-tetramethylene, α,ω-hexamethylene, α,ω-dodecamethylene, α,ω-2-methylpentamethylene, α,ω-2,2,4-trimethylhexamethylene, cyclohexyl (1,4-), 1-methylcyclohexyl (1,3-; 1,4-; 2,6-), 2,2,6-trimethylcyclohexyl, isophorone (3,3,5-trimethylcyclohexyl), 4,4′-dicyclohexylmethyl, 4,4′-dicyclohexylpropane-(2,2), 4,4′-diphenylmethane, preferably hexamethylene, 4,4′-diphenylmethane and isophorone,
R^{x} is independently the bonding site to component b) and component c),
and denotes a urethane group or urea group in the case of the bond to component b),
and denotes a urethane group, a urea group or a thiourea group in the case of the bond to component c),
where these urethane, urea and thiourea groups are bonded via the nitrogen atom to formula (III) and formula (IV),
or R^{x} denotes a bond to a further biuret or isocyanurate substructure;
and have, as component b), preferably a polysiloxane of the formula (I)
M¹ₐ₁M²ₐ₂M³ₐ₃D¹_{b1}D²_{b2}D³_{b3}T_{c}Q_{d} (I)
with

| | | |
|---|---|---|
| M¹ = [R¹₃SiO_{1/2}], | M² = [R²R¹₂SiO_{1/2}], | M³ = [R³R¹₂SiO_{1/2}], |
| D¹ = [R¹₂SiO_{2/2}], | D² = [R¹R²SiO_{2/2}], | D³ = [R¹R³SiO_{2/2}], |
| T = [R¹SiO_{3/2}], | | |
| Q = [SiO_{4/2}], | | |

where
a1=0 to 20;
a2=0 to 10;
a3=0 to 20;
b1=1 to 1000;
b2=0 to 10;
b3=0 to 20;
c=0 to 10;
d=0 to 50;
wherein at least one of the indices a3 and b3 is greater than 1, the sum total of a3 and b3;
R¹=independently identical or different linear or branched, saturated or unsaturated hydrocarbyl radicals having 1 to 30 carbon atoms or aromatic hydrocarbyl radicals having 6 to 30 carbon atoms;
R²=independently identical or different linear or branched, saturated or unsaturated, optionally substituted hydrocarbyl radicals, where the substituents may be selected from methoxy, ethoxy, propoxy, butoxy, pentoxy and glycidyloxy,
R³=a divalent hydrocarbon having 2 to 8 carbon atoms, the second bond of which is the bonding site to component a) via a urethane or urea group;
and have, as component c), hydrocarbons having exactly one bonding site to component a), the hydrocarbons is preferably having, aside from carbon and hydrogen, not more than 3 heteroatoms; if component c) has heteroatoms.

7. The copolymer according to claim 6 have in component a), as divalent L radical in the formula (III) or (IV), hexamethylene, 4,4′-diphenylmethane and isophorone;
in component b), a siloxane of the formula (I) with the indices
a3=2 to 5
a1=0 to 1
a2=0
b2 and b3=0
d=0
R¹=methyl or phenyl
in component c), a hydrocarbon which is free of heteroatoms and has aromatic rings.

8. A process for preparing the copolymer according to claim 1, wherein, in the first step, an intermediate comprising components a) and components c) is prepared and, in the second step, the intermediates are converted to the copolymer.

9. A composition comprising the copolymer according to claim 1 and additives and/or auxiliaries.

10. An aqueous emulsion comprising the copolymer according to claim 1.

11. The composition according to claim 9 comprising, as at least one additive, a booster, preferably a polycarbodiimide.

12. A fabric finishing composition comprising the compositions or aqueous emulsions according to claim 9.

13. A method of liquid- and soil-repellent impregnation of textile fabrics by using the copolymers according to claim 1.

14. The method of liquid- and soil-repellent impregnation of textile fabrics according to claim 13.

15. The repellent textile fabric comprising the copolymer according to claim 1.

16. The copolymer according to claim 1 wherein component a) is a polysiloxane.

17. The copolymer according to claim 1 are free of fluorine atoms and are free of oxyalkylene fragments bonded to one another.

18. The copolymer according to claim 1 have component a) and component c) in a ratio of number of c) divided by number of a) of 1.8 to 2.2.

19. The copolymer according to claim 1 each have, in component a), from 1 to 4 biuret or isocyanurate substructures.
